(19) United States
(12) Patent Application Publication
(10) Pub. No.: US 2018/0029205 A1
(43) Pub. Date: Feb. 1, 2018

(54) ROTARY TOOL ANVIL ASSEMBLY

(71) Applicant: INGERSOLL-RAND COMPANY, DAVIDSON, NC (US)

(72) Inventor: Patrick S. Livingston, Easton, PA (US)

(21) Appl. No.: 15/220,279

(22) Filed: Jul. 26, 2016

(51) Int. Cl. B25B 21/02; B25B 23/00

(52) U.S. Cl. CPC B25B 21/02; B25B 23/0035

(57) ABSTRACT

An anvil assembly for a rotary tool is provided. The anvil assembly includes an anvil body having a cylindrical portion operably coupled to the rotary tool's drive mechanism and having a drive output portion configured to releasably engage a corresponding socket thereon. The anvil body may also have a transition region between a shape of the drive output portion and a shape of the cylindrical portion, wherein the transition region gradually transitions the shape of the drive output portion to the shape of the cylindrical portion. A collar may be releasably coupled to the anvil body, the collar having a first end and a second end, the first end configured to engage the shape of the drive output portion and the second end configured to engage the cylindrical portion, wherein the first end has a flat face defining a shoulder for contacting the socket releasably engaged on the anvil body.

### BACKGROUND

### Technical Field

The present disclosure relates to rotary tools, and in particular to anvil geometry of rotary tools.

### State of the Art

A powered rotary tool may be used in conjunction with a corresponding mated socket to manipulate many different types of workpieces, for example, mechanical fasteners, such as bolts, nuts, etc. These rotary tools employ a rotating mass, such as a shaft or anvil, on which the mated socket is releasably coupled, which anvil is accelerated by a motor or other power source within the rotary tool, to apply torque to the socket to thereby manipulate the workpiece.

Conventionally, the anvil of the rotary tool has a cylindrical portion and a square-shaped portion. With regard to the cylindrical portion, the mating part of the motor or other drive means within the rotary tool is cylindrical and therefore requires the corresponding portion of the anvil to be likewise cylindrical. However, to impart rotational force to the socket, the opposing end of the anvil must exhibit flat or square- shaped surfaces to engage with the corresponding flat or square-shaped surfaces of the socket and cause it to turn.

Conventional anvils also include a shoulder positioned somewhere between the cylindrical portion and the square-shaped portion, with the shoulder being a sloping surface to transition the anvil from the square shape to the cylindrical shape and to contact the socket placed on the anvil. Because of the change in geometry at or near the shoulder, or the transition between the square and cylindrical shapes, the shoulder may create a weak point in the anvil where stress concentrations may initiate points of failure.

It would therefore be advantageous to address these concerns and provide an anvil that decreases the amount of stress concentrations thereon.

### SUMMARY

The present disclosure relates to rotary tools, and in particular to anvil geometry of rotary tools and an anvil assembly for rotary tools.

An aspect of the present disclosure includes an anvil assembly for a rotary tool, the assembly comprising: an anvil body having a cylindrical portion operably coupled to a drive mechanism of the rotary tool and having a drive output portion configured to releasably engage a corresponding socket thereon; a transition region between a shape of the drive output portion and a shape of the cylindrical portion, wherein the transition region gradually transitions the shape of the drive output portion to the shape of the cylindrical portion; and a collar releasably coupled to the anvil body, the collar having a first end and a second end, the first end configured to engage the shape of the drive output portion and the second end configured to engage the cylindrical portion, wherein the first end has a flat face defining a shoulder for contacting the socket releasably engaged on the anvil body.

Another aspect of the present disclosure includes an anvil assembly of a rotary tool, the assembly comprising: an anvil body having a cylindrical portion operably coupled to a drive mechanism of the rotary tool and a drive output portion configured to releasably engage a corresponding socket thereon; a transition region between a shape of the drive output portion and a shape of the cylindrical portion, wherein the transition region gradually transitions the shape of the drive output portion to the shape of the cylindrical portion; and a shoulder for contacting the socket releasably engaged on the anvil body, wherein the shoulder and the anvil body are releasably coupled together.

Another aspect of the present disclosure includes an anvil assembly of a rotary tool, the assembly comprising: an anvil body having a cylindrical portion operably coupled to a drive mechanism of the rotary tool and a drive output portion configured to releasably engage a corresponding socket thereon; a collar releasably coupled by press fit to the anvil body, the collar having a first end and a second end, the first end configured to physically engage a shape of the drive output portion and the second end configured to physically engage the cylindrical portion, wherein the first end defines a shoulder for contacting the socket releasably engaged on the anvil body.

The foregoing and other features, advantages, and construction of the present disclosure will be more readily apparent and fully appreciated from the following more detailed description of the particular embodiments, taken in conjunction with the accompanying drawings.

### BRIEF DESCRIPTION OF THE DRAWINGS

Some of the embodiments will be described in detail, with reference to the following figures, wherein like designations denote like members:

FIG. 1 is a partial, side perspective view of an illustrative embodiment of a conventional anvil of a rotary tool.

FIG. 2 is a cross-sectional side view of an embodiment of a rotary tool anvil assembly for a rotary tool in accordance with the present disclosure.

FIG. 3 is a side perspective view of an embodiment of a component of a rotary tool anvil assembly for a rotary tool in accordance with the present disclosure.

### DETAILED DESCRIPTION OF EMBODIMENTS

A detailed description of the hereinafter described embodiments of the disclosed apparatus and method are presented herein by way of exemplification and not limitation with reference to the Figures listed above. Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure.

As a preface to the detailed description, it should be noted that, as used in this specification and the appended claims, the singular forms “a”, “an” and “the” include plural referents, unless the context clearly dictates otherwise.

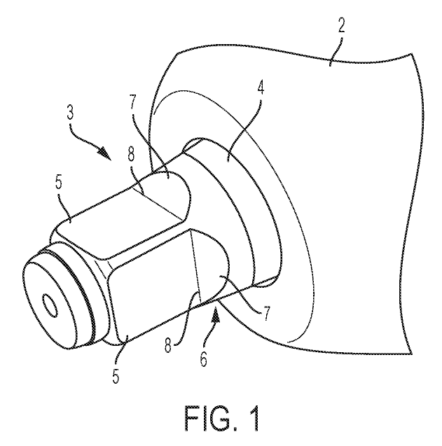

With reference to FIG. 1, a conventional rotary tool 2, such as an impact wrench and the like, may have a rotating mass therein that is accelerated by the motor. The rotating mass stores energy, then suddenly delivers the stored energy to an output shaft of the rotary tool to create a high-torque impact. This impact, or rotational force or energy, is exerted on a body mass extending out of the motor housing, such as an anvil 3, which typically has a cylindrical shaft portion 4 and a drive output portion 5.

The cylindrical shaft portion 4 is shaped in a cylinder so that the bearings or bushings that cause the shaft to rotate can do so with a smooth motion, facilitating more of the force being transferred to the tooling, and therefore the part that the operator wishes to rotate. However, in order for the rotational force to be transferred to the tooling, such as a socket wrench, the opposing end of the cylindrical shaft, or the drive output portion 5, is configured in a specific shape. The most common shape is a square, although other shapes, such as pentagons, can be used. Thus, the cylindrical shaft portion 4 is transitioned from a cylindrical shape into a shape of the drive output portion 5.

The transition from the cylindrical shaft portion 4 to the drive output portion 5 is typically achieved in a transition portion 6 having a shoulder 7. The shoulder 7 is typically an angled surface that abruptly changes slope from the cylindrical shaft portion 4 to the drive output portion 5. As such, points 8 on the anvil 3 where the drive output portion 5 meets the shoulder 7 typically define abrupt geometric changes or sharp discontinuities of slope that create potential weaknesses in the mechanical integrity of the anvil 3, or otherwise concentrate operational stresses on the anvil 3, either of which could lead to failure of the anvil 3 over time.

Yet, conventional rotary tools 2 are purposefully designed with the shoulder 7 having sharp discontinuities of slope and abrupt changes in geometry to provide a physical shoulder 7 against which a socket may rest. For example, a socket may be inserted on the drive output portion 5, such that a user may manipulate the rotary tool 2 to spin the drive output portion 5 and thus the socket to impart force to a workpiece, such as a bolt, nut, etc. Because the shoulder 7 abruptly changes geometry at the point 8, the end of the socket may rest against, or at least abut, the shoulder 7 to prevent the socket from axially advancing further up the drive output portion 5 toward the cylindrical shaft portion 4. In this way, the shoulder 7 functions to position the socket appropriately on the anvil 3 during operation of the rotary tool 2.

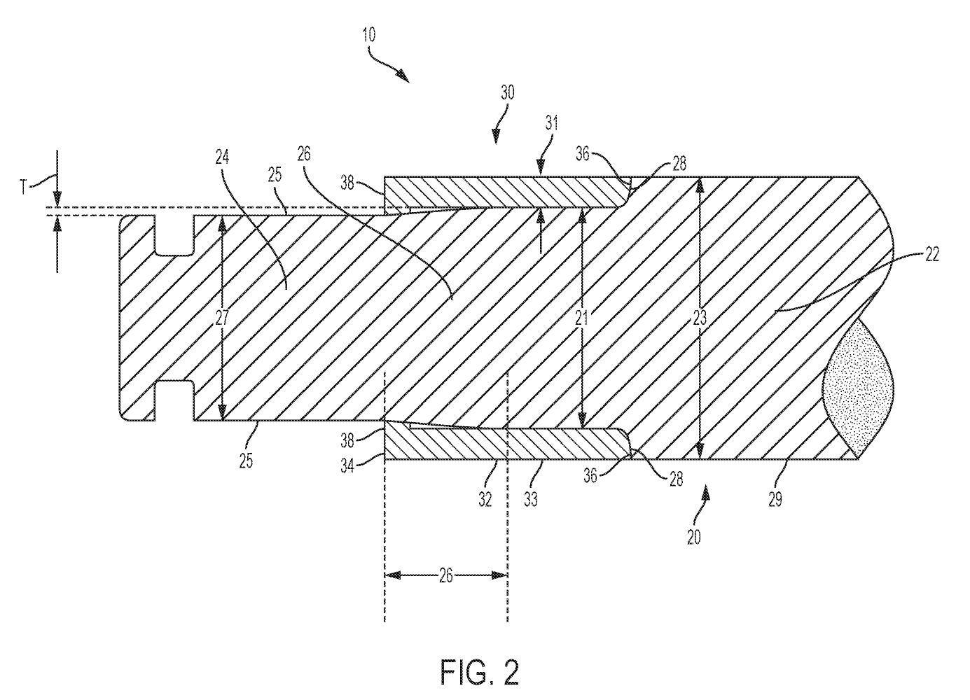

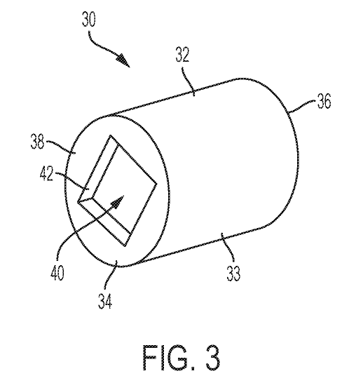

FIGS. 2 and 3 depict illustrative embodiments of a rotary tool anvil assembly 10 of the present invention. The embodiments may each comprise various structural and functional components that complement one another to provide the unique functionality and performance of the anvil assembly 10, the particular structure and function of which will be described in greater detail herein. For example, embodiments of the anvil assembly 10 may comprise an anvil body 20 and a collar 30, among other component parts.

Embodiments of the anvil assembly 10 may comprise an anvil body 20. The anvil body 20 may be an elongated member having a cylindrical portion 22 on an end and a drive output portion 24 on an opposing end, with a transition region 26 positioned therebetween. The anvil body 20 may be a substantially rigid body. The anvil body 20 may also be an integral body, with the cylindrical portion 22, the drive output portion 24, and the transition region 26 being formed of a single integral piece. The anvil body 20 may have an axis about which the anvil body 20 rotates, the axis of the anvil body 20 corresponding to the axis of rotation of the rotary tool 2. The anvil body 20 may be configured to receive rotational input from the drive system or motor of the rotary tool 2, such that the anvil body 20 may be powered by the rotary tool 2.

Embodiments of the anvil assembly 10 may comprise the cylindrical portion 22 of the anvil body 20 being shaped in the form of a cylinder to receive, accommodate and otherwise facilitate the rotational input of the drive system or motor of the rotary tool 2 to the anvil body 20. The cylindrical portion 22 may further comprise an annular ridge 28 therein. The annular ridge 28 may be a rise or increase in the diameter of the cylindrical portion 22, such that the cylindrical portion 22 may have a first diameter 21 and a second diameter 23, with the second diameter 23 being larger than the first diameter 21. The second diameter 23 may be sized and configured to communicate with the diameter of the drive system or motor of the rotary tool 2, whereas the first diameter 21 may be sized and configured to communicate with the transition region 28 and a collar 30, to be described in detail herein.

Embodiments of the anvil assembly 10 may comprise the drive output portion 24 of the anvil body 20 being positioned on an opposing end of the anvil body 20 from the cylindrical portion 22 and configured in a predetermined or desired size and shape. The size and shape may be chosen, or otherwise manufactured, to correspond to a hollow or opening of a socket, such that the drive output portion 24 may be inserted into and engage the hollow or opening of the socket to thereby drive the socket in its intended operation on a workpiece, such as a bolt, nut, etc. For example, the drive output portion 24 may be shaped in the shape or form of a square having flat or horizontal surfaces 25 configured to engage the corresponding flat or horizontal surfaces of the hollow or opening of the socket. In this way, once the socket is engaged on the drive output portion 24, the rotation of the anvil body 20 from the rotation of the drive system of the rotary tool 2 may cause the flat or horizontal surfaces 25 to physically contact the corresponding flat or horizontal surfaces of the hollow or opening of the socket to drive the rotation of the socket.

Embodiments of the anvil assembly 10 may comprise a transition region 26 positioned between the drive output portion 24 and the cylindrical portion 22. The transition region 26 may be configured to transition the width 27 of the drive output portion 24 to the first diameter 21 of the cylindrical portion 22. Thus, the transition region 26 may increase in dimension in an axial direction from the drive output portion 24 to the first diameter 21 of the cylindrical portion 22. For example, the transition region 26 may have an initial dimension that matches the width 27 of the drive output portion 24, and that initial dimension may gradually increase in size in the axial direction until the dimension of the transition region 26 matches the size of the first diameter 21. In some embodiments, the transition region 26 may therefore be described as increasing in dimension in a substantially smooth manner in an axial direction. Additionally, in some embodiments, the transition region 26 may be described as increasing in dimension in a substantially continuous manner without abrupt changes in slope in an axial direction. Additionally, in some embodiments, the transition region 26 may be described as being substantially void of sharp discontinuities while increasing in dimension in an axial direction. Additionally, in some embodiments, the transition region 26 may be described as exhibiting smooth curvilinear blending while increasing in dimension in an axial direction.

Embodiments of the anvil assembly 10 may comprise the difference between the width 27 of the drive output portion 24 and the first diameter 21 of the cylindrical portion 22 being the transition difference T. In some embodiments, the transition difference T may be less than half the size of the width 31 of the collar 30, which may be measured between the first diameter 21 and the exterior surface 33 of the collar 30. As such, over the axial length of the transition region 26, or at least a portion thereof, the transition region 26 increases in dimension, according to the description herein, by the transition difference T. The transition difference T may be held to a minimum by the cylindrical portion 22 having the first diameter 21 that is smaller than the second diameter 23. With the transition difference T kept relatively small, the transition region 26 may likewise be kept to a small incline or gradual rise, as described herein. Accordingly, due to the improved geometry of the transition region 26, the typical weak points 8, owing to sharp inclines, sharp slope changes, and sharp discontinuities, that are found in conventional anvils 3, are eliminated from the anvil body 20. As such, the anvil body 20 does not incur the concentrated stresses and strains that conventional anvils 3 can experience.

Embodiments of the anvil assembly 10 may comprise a collar 30. The collar 30 may be an elongated body 32 having, generally, the shape of an annulus when viewed along an axis of rotation. The axis of rotation of the collar 30 may correspond to the axis of rotation of the anvil body 20 and the axis of the drive system or motor of the rotary tool 2. The collar 30 may be a substantially rigid body having a first end 34 and a second end 36 that opposes the first end 34. The second end 36 may be open, such that the collar 30 may be inserted over at least portions of the anvil body 20 through the open second end 36. The first end 34 may have a face 38. The face 38 may define a substantially flat surface. The surface of the face 38, in some embodiments, may be oriented substantially orthogonally to the axis of rotation of the collar 30, and thus the axis of rotation of the anvil body 20 and the rotary tool 2. In this way, the face 38 may be substantially perpendicular to the drive output portion 24 and/or the flat surfaces 25 thereof. The face 38 may further define an opening 40. The opening 40 may axially extend entirely through the face 38 such that the opening 40 communicates with the interior of the collar 30. The opening 40 may be configured in a size and shape to match or otherwise correspond to the size and shape of the drive output portion 24. The opening 40 may further comprise interior surfaces 42 that may be oriented in parallel with the axis of rotation of the collar 30, and thus the axis of rotation of the anvil body 20 and the rotary tool 2. In this way, the interior surfaces 42 may be substantially parallel to the drive output portion 24 and/or the flat surfaces 25 thereof. The interior surfaces 42 may be configured to engage the surfaces of the anvil body 20. The collar 30 may further comprise an exterior surface 33 that may be cylindrically shaped due to the annular shape of the body 32. As a result, the face 38 may be a flat face extending from the surface of the rigid body 20 up to the exterior surface 33 of the collar 30.

Embodiments of the anvil assembly 10 may comprise the collar 30 being inserted over portions of the anvil body 20 to releasably couple thereto. For example, the second end 36 of the collar 30 may be inserted onto the anvil body 20 and axially transitioned down the anvil body 20 until the second end 36 physically contacts the annular ridge 28 and/or the interior of the collar 30 proximate the second end 36 physically engages the first diameter 21 of the cylindrical portion 22. The collar 30 may engage the first diameter 21 by press fit. In like manner, the first end 34 of the collar 30 may be inserted over the rigid body 20 and axially advanced so that the opening 40 physically contacts or otherwise engages the drive output portion 24. The collar 30 may have an axial length that permits the second end 36 to physically contact the annular ridge 28 while the interior surfaces 42 of the opening 40 physically contact or otherwise engage the drive output portion 24 proximate where the drive output portion 24 transitions to the transition region 26. The exterior surface 33 of the collar 30 and the exterior surface 29 of the cylindrical portion 22 may be configured to be flush with one another in a radial direction.

With the collar 30 engaged on the rigid body 20, the face 38 may be positioned with respect to the rigid body 20, and, in particular, to the drive output portion 24, such that the face 38 may function as a stop or shoulder, similar to the shoulder 7 of a conventional rotary tool 2. Yet, because the face 38 is separate and apart from the geometry of the rigid body 20, the face 38 may function as a shoulder without the rigid body 20 exhibiting sharp changes in slope or abrupt discontinuities, as described herein. As a result, the anvil assembly 10 is advantageous over conventional anvils 3 due to the rigid body 20 being substantially void of conventional weak points 8 that would otherwise expose or suspect conventional anvils 3 to failure, while at the same time providing the shoulder (i.e., face 38) against which a socket can rest or contact when the socket is releasably coupled to the drive output portion 24.

The materials of construction of the anvil assembly 10 and its various component parts may vary considerably, depending on the temperatures and pressures to which they will be subjected and the nature of the applications for which they will be used. For example, materials used for other rotary power tool shaft mechanisms, such as metals, metal alloys and the like may be employed. Further, operation under certain conditions may dictate the use of other materials known for such purposes.

Furthermore, the components defining the above-described anvil assembly 10 may be purchased pre-manufactured or manufactured separately and then assembled together. However, any or all of the components may be manufactured simultaneously and integrally joined with one another. Manufacture of these components separately or simultaneously may involve extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, 3-D printing, and/or the like. If any of the components are manufactured separately, they may then be coupled with one another in any manner, such as with adhesive, a weld, a fastener (e.g. a bolt, a nut, a screw, a nail, a rivet, a pin, and/or the like), wiring, any combination thereof, and/or the like for example, depending on, among other considerations, the particular material forming the components. Other possible steps might include sand blasting, polishing, powder coating, zinc plating, anodizing, hard anodizing, and/or painting the components for example.

While this disclosure has been described in conjunction with the specific embodiments outlined above, it is evident that many alternatives, modifications and variations will be apparent to those skilled in the art. Accordingly, the preferred embodiments of the present disclosure as set forth above are intended to be illustrative, not limiting. Various changes may be made without departing from the spirit and scope of the present disclosure, as required by the following claims. The claims provide the scope of the coverage of the present disclosure and should not be limited to the specific examples provided herein.

What is claimed is:

1. An anvil assembly for a rotary tool, the assembly comprising:
an anvil body having a cylindrical portion operably coupled to a drive mechanism of the rotary tool and having a drive output portion configured to releasably engage a corresponding socket thereon;
a transition region of the anvil body positioned between a shape of the drive output portion and a shape of the cylindrical portion, wherein the transition region gradually transitions the shape of the drive output portion to the shape of the cylindrical portion; and
a collar releasably coupled to the anvil body, the collar having a first end and a second end, the first end configured to engage the shape of the drive output portion and the second end configured to engage the cylindrical portion,
wherein the first end has a face defining a shoulder for contacting the socket releasably engaged on the anvil body.

2. The assembly of claim 1, wherein the face defines an opening having the shape of the drive output portion.

3. The assembly of claim 2, wherein the opening defined by the face engages the shape of the drive output portion by press fit.

4. The assembly of claim 2, wherein the face engages the drive output portion proximate where the drive output portion meets the transition region.

5. The assembly of claim 1, wherein the face is substantially orthogonal to the shape of the drive output portion.

6. The assembly of claim 1, further comprising an annular ridge in the anvil body proximate where the transition region meets the cylindrical portion, wherein the second end of the collar contacts the annular ridge.

7. The assembly of claim 6, wherein exterior surfaces of the cylindrical portion and the second end are flush with one another where the second end contacts the annular ridge.

8. The assembly of claim 1, wherein the transition region exhibits a substantially smooth increase in dimension in an axial direction.

9. The assembly of claim 1, wherein the drive output portion, the transition region, and the cylindrical portion are integrally formed.

10. An anvil assembly of a rotary tool, the assembly comprising:
an anvil body having a cylindrical portion operably coupled to a drive mechanism of the rotary tool and a drive output portion configured to releasably engage a corresponding socket thereon;
a transition region of the anvil body positioned between a shape of the drive output portion and a shape of the cylindrical portion, wherein the transition region gradually transitions the shape of the drive output portion to the shape of the cylindrical portion; and
a shoulder for contacting the socket releasably engaged on the anvil body, wherein the shoulder and the anvil body are releasably coupled together.

11. The assembly of claim 10, further comprising a collar having a first end and a second end, wherein the first end has a face defining the shoulder.

12. The assembly of claim 11, wherein the first end is configured to engage the shape of the drive output portion and the second end is configured to engage the cylindrical portion.

13. The assembly of claim 12, wherein the face defines an opening having the shape of the drive output portion.

14. The assembly of claim 13, wherein the opening defined by the face engages the shape of the drive output portion by press fit.

15. The assembly of claim 13, wherein the face engages the drive output portion proximate where the drive output portion meets the transition region.

16. The assembly of claim 11, wherein the face is substantially orthogonal to the shape of the drive output portion.

17. The assembly of claim 10, wherein the transition region is substantially void of sharp discontinuities in an axial direction.

18. The assembly of claim 10, wherein the drive output portion, the transition region, and the cylindrical portion are integrally formed.

19. An anvil assembly of a rotary tool, the assembly comprising:
an anvil body having a cylindrical portion operably coupled to a drive mechanism of the rotary tool and a drive output portion configured to releasably engage a corresponding socket thereon;
a collar releasably coupled by press fit to the anvil body, the collar having a first end and a second end, the first end configured to physically engage a shape of the drive output portion and the second end configured to physically engage the cylindrical portion,
wherein the first end defines a shoulder for contacting the socket releasably engaged on the anvil body.

20. The assembly of claim 19, further comprising a transition region between the drive output portion and the cylindrical portion, wherein the transition region gradually transitions the shape of the drive output portion to the shape of the cylindrical portion, and wherein the collar substantially covers the transition region.
